(19) United States
(12) Patent Application Publication
(10) Pub. No.: US 2025/0225498 A1
(43) Pub. Date: Jul. 10, 2025

(54) METHOD AND SYSTEM FOR PEER-TO-PEER TRANSACTION USING BLOCKCHAIN

(71) Applicant: LINE NEXT Corporation, Seongnam-si (KR)

(72) Inventors: Yooho KIM, Seongnam-si (KR); Jungchul KIM, Seongnam-si (KR); Heesun KIM, Seongnam-si (KR); Pil-Su SEO, Seongnam-si (KR); Yoonyoul YOO, Seongnam-si (KR); Jaemoon JUNG, Seongnam-si (KR); Jong Min TAK, Seongnam-si (KR); Sung Taek WANG, Seongnam-si (KR); Hui Seong BAK, Seongnam-si (KR); Bae Jun BAE, Seongnam-si (KR); Sung Yong KANG, Seongnam-si (KR); Sang Duck LEE, Seongnam-si (KR); Yeojin KIM, Seongnam-si (KR); Jungmin SUNG, Seongnam-si (KR); Seil JEONG, Seongnam-si (KR)

(73) Assignee: LINE NEXT Corporation, Seongnam-si (KR)

(21) Appl. No.: 19/010,753

(22) Filed: Jan. 6, 2025

(30) Foreign Application Priority Data
Jan. 5, 2024 (KR) 10-2024-0002035
Feb. 13, 2024 (KR) 10-2024-0020567

(51) Int. Cl. G06Q 20/22; G06Q 20/06; G06Q 20/36

(52) U.S. Cl. CPC G06Q 20/223; G06Q 20/06; G06Q 20/36

(57) ABSTRACT

A peer-to-peer (P2P) transaction method may include issuing a service identifier associated with a first service among a plurality of services provided through different service providers; providing a sealing request function associated with an item available within the first service and a submission request function associated with a token to the first service to which the service identifier is issued; receiving a sealing request of first user associated with the item through the sealing request function from the first service; requesting the first service associated with sealing of the item in response to the sealing request; generating a token containing the service identifier and ownership of the first user associated with the item through a blockchain network; receiving a submission request associated with the token of the first user through the submission request function from the first service; and processing transaction for the token in response to the submission request.

### CROSS-REFERENCE TO RELATED APPLICATION(S)

This U.S. non-provisional application and claims the benefit of priority under 35 U.S.C. § 119 to Korean Patent Application No. 10-2024-0002035, filed Jan. 5, 2024, and Korean Patent Application No. 10-2024-0020567, filed Feb. 13, 2024, the entire contents of each of which are incorporated herein by reference in their entirety.

### BACKGROUND

Some example embodiments relate to a method and system associated with peer-to-peer (P2P) transactions using a blockchain.

Blockchain has features including proving ownership through a public network. Using this, the blockchain is being used as a method of proving ownership in a variety of areas ranging from currency and digital content to real estate. Using the blockchain, it may be possible to prove ownership recorded in a token, and transactions may be recorded and profits may be distributed within decentralized blockchain through programming-based contracts such as smart contract.

Reference material includes Korean Patent Registration No. 10-2388233.

### SUMMARY

Some example embodiments provide a method and system for peer-to-peer (P2P) transaction using blockchain.

According to at least some example embodiments, there is provided a peer-to-peer (P2P) transaction method of a computer device comprising at least one processor, the P2P transaction method comprising issuing, by the at least one processor, a service identifier associated with a first service among a plurality of services, the plurality of services being provided through different service providers; providing, by the at least one processor, a sealing request function associated with an item available within the first service and a submission request function associated with a token to the first service to which the service identifier is issued; receiving, by the at least one processor, a sealing request of a first user associated with the item through the sealing request function from the first service; requesting, by the at least one processor, the first service associated with sealing of the item in response to the sealing request; generating a token containing the service identifier and ownership of the first user associated with the item through a blockchain network; receiving, by the at least one processor, a submission request for the token of the first user through the submission request function from the first service; and processing, by the at least one processor, a transaction associated with the token in response to the submission request.

According to some example embodiments, the receiving of the sealing request may include further receiving an item identifier of the item, and the generating of the token comprises generating the token further containing the item identifier of the item received with the sealing request.

According to some example embodiments, the providing may include further providing an unsealing request function associated with the token to the first service, and the P2P transaction method further comprises: receiving, by the at least one processor, an unsealing request of a second user having ownership of the token through the unsealing request function from the first service; retrieving, by the at least one processor, the token from an electronic wallet (E-wallet) of the second user in response to the unsealing request; and requesting the first service associated with unsealing of the item corresponding to the token.

According to some example embodiments, the requesting may include moving the token from the E-wallet of the second user to another E-wallet, the moving the token associated with retrieval; and changing the token to be in an unusable state.

According to some example embodiments, the second user is same user as the first user or is another user having purchased the token from the first user.

According to some example embodiments, the issuing of the service identifier may include receiving partner information and information on a revenue share (R/S) ratio including commission for item transaction, the receiving partner information and information on an R/S ratio from an administrator of the first service; registering the first service based on the received partner information and information on the R/S ratio; and generating and providing a service identifier for the registered first service.

According to some example embodiments, the issuing of the service identifier may include further issuing a right to use software development kit (SDK) associated with implementation of the sealing request function and the submission request function to the first service.

According to some example embodiments, the processing of the transaction may include registering the token through a centralized exchange and processing the transaction of the token.

According to some example embodiments, the processing of the transaction may include registering the token through a decentralized exchange implemented through at least some nodes among nodes included in the blockchain network, and processing the transaction of the token.

According to some example embodiments, the decentralized exchange may process the transaction of the token based on a signature on smart contract deployed to the at least some nodes.

According to some example embodiments, there is provided a non-transitory computer-readable recording medium storing instructions that, when executed by a processor, cause the processor to implement the method on the computer device.

According to some example some example embodiments, there is provided at least one processor configured to execute computer-readable instructions, wherein the at least one processor causes the computer device to, issue a service identifier associated with a first service among a plurality of services provided through different service providers, provide a sealing request function associated with an item available within the first service and a submission request function for a token to the first service to which the service identifier is issued, receive a sealing request of a first user associated with the item through the sealing request function from the first service, request the first service associated with sealing of the item in response to the sealing request, generating a token containing the service identifier and ownership of the first user associated with the item through a blockchain network, receive a submission request associated with the token of the first user through the submission request function from the first service, and process a transaction for the token in response to the submission request.

According to some example embodiments, the at least one processor may further the computer device to, further provide an unsealing request function associated with the token to the first service, receive an unsealing request of a second user having ownership of the token through the unsealing request function, the receiving the unsealing request from the first service, and retrieve the token from an electronic wallet (E-wallet) of the second user in response to the unsealing request and request the first service for unsealing of an item corresponding to the token.

According to some example embodiments, in issuing the service identifier, the at least one processor may cause the computer device to, receive partner information and information on a revenue share (R/S) ratio including commission for item transaction, the receiving partner information and information on the R/S ratio from an administrator of the first service, register the first service based on the received partner information and on information on the R/S ratio, and generate and provide a service identifier for the registered first service.

According to some example embodiments, it may be possible to provide a method and/or a system for P2P transaction using blockchain.

Further areas of applicability will become apparent from the description provided herein. The description and specific examples in this summary are intended for purposes of illustration only and are not intended to limit the scope of inventive concepts.

### BRIEF DESCRIPTION OF DRAWINGS

FIG. 1 is a diagram illustrating an example of a network environment according to some example embodiments;

FIG. 2 is a diagram illustrating an example of a computer device according to some example embodiments;

FIG. 3 illustrates an example of a peer-to-peer (P2P) transaction system using blockchain according to some example embodiments;

FIG. 4 illustrates an example of a P2P transaction process according to some example embodiments;

FIG. 5 illustrates an example of a process of sealing an item according to some example embodiments;

FIG. 6 illustrates an example of a process of unsealing a sealed item according to some example embodiments;

FIG. 7 illustrates an example of a sealing process according to some example embodiments;

FIG. 8 illustrates an example of an unsealing process according to some example embodiments;

FIG. 9 illustrates an example of token information for trading items of a plurality of services according to some example embodiments;

FIG. 10 illustrates an example of a process of receiving a service identifier issued from each service and using a software development kit (SDK) for sealing and/or unsealing according to some example embodiments; and

FIG. 11 is a flowchart illustrating an example of a P2P transaction method according to some example embodiment.

### DETAILED DESCRIPTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those of ordinary skill in the art. Accordingly, processes, elements, and techniques, such as known processes, elements, and techniques, may not be described with respect to some example embodiments. Unless otherwise noted, like reference characters denote like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Hereinafter, some example embodiments will be described with reference to the accompanying drawings.

A peer-to-peer (P2P) transaction system according to some example embodiments may be implemented by at least one computer device. Here, a computer program according to an example embodiment may be installed and run on the computer device and the computer device may perform a P2P transaction method according to example embodiments under control of the computer program. The aforementioned computer program may be stored in a computer-readable record medium to implement the P2P transaction method in conjunction with the computer device.

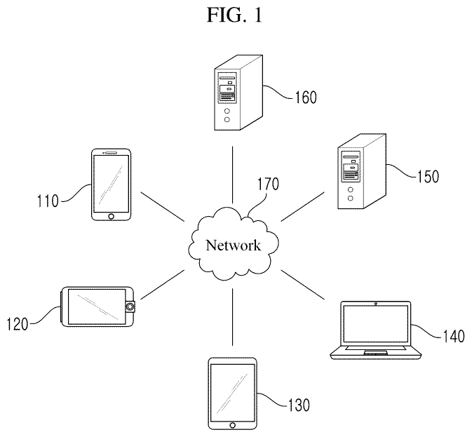

FIG. 1 illustrates an example of a network environment according to some example embodiments. Referring to FIG. 1, the network environment may include a plurality of electronic devices 110, 120, 130, and 140, a plurality of servers 150 and 160, and a network 170. FIG. 1 is provided as an example only. The number of electronic devices and/or the number of servers is not limited thereto. Also, the network environment of FIG. 1 is provided as one example of environments applicable to some example embodiments and an environment applicable to some example embodiments is not limited to the network environment of FIG. 1.

Each of the plurality of electronic devices 110, 120, 130, and 140 may be or may include a fixed terminal or a mobile terminal that is configured as a computer device. For example, the plurality of electronic devices 110, 120, 130, and 140 may be or may include, or be included in, one or more of a smartphone, a mobile phone, a navigation device, a computer, a laptop computer, a digital broadcasting terminal, a personal digital assistant (PDA), a portable multimedia player (PMP), a tablet PC, and the like. For example, although FIG. 1 illustrates a shape of a smartphone as an example of the electronic device 110, the electronic device 110 used herein may refer to one of various types of physical computer devices capable of communicating with other electronic devices 120, 130, and 140, and/or the servers 150 and 160 over the network 170 in a wireless and/or wired communication manner. In some cases, the electronic devices 120, 130, and 140 may communicate with each other and/or with the network, for example in a broadcast manner, a one-to-one manner, and/or a one-to-many manner, to exchange data such as information and/or instructions, in a serial and/or parallel manner. The information may be or may include digital information and/or analog information; example embodiments are not limited thereto.

The communication scheme is not limited and may include a near field wireless communication scheme between devices as well as or alternatively to a communication scheme using a communication network (e.g., one or more of a mobile communication network, wired Internet, wireless Internet, and a broadcasting network) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet. Alternatively or additionally, the network 170 may include at least one of network topologies that include a bus network, a star network, a ring network, a mesh network, a star-bus network, a tree or hierarchical network, and the like. However, these are provided as examples only and are not limited thereto.

Each of the servers 150 and 160 may be configured as a computer device or a plurality of computer devices that provides one or more of an instruction, a code, a file, content, a service, etc., through communication with the plurality of electronic devices 110, 120, 130, and 140 over the network 170. For example, the server 150 may be or may include (or be included in) a system that provides a service to the plurality of electronic devices 110, 120, 130, and 140 connected over the network 170.

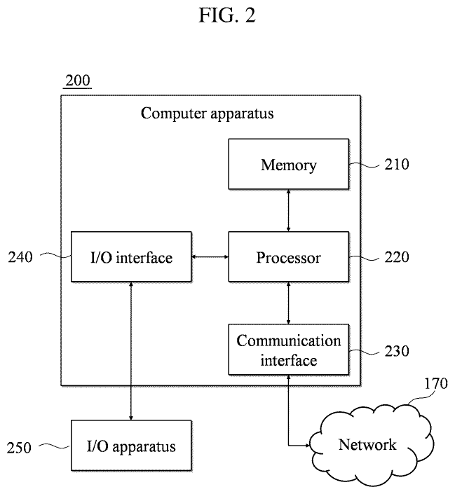

FIG. 2 is a block diagram illustrating an example of a computer device according to some example embodiments. Each of or at least one of the plurality of electronic devices 110, 120, 130, and 140, and/or each of or at least one of the servers 150 and 160 may be implemented by a computer device 200 of FIG. 2.

Referring to FIG. 2, the computer device 200 may include a memory 210, a processor 220, a communication interface 230, and an input/output (I/O) interface 240. The memory 210 may include a permanent mass storage device, such as one or more of a random access memory (RAM), a read only memory (ROM), and a disk drive, as a non-transitory computer-readable record medium. The permanent mass storage device, such as ROM and a disk drive, may be included in the computer device 200 as a permanent storage device separate from the memory 210. In some example embodiments, an OS and at least one program code may be stored in the memory 210. Such software components may be loaded to the memory 210 from another non-transitory computer-readable record medium separate from the memory 210. The other non-transitory computer-readable record medium may include a non-transitory computer-readable record medium, for example, a floppy drive, a disk, a tape, a DVD/CD-ROM drive, a memory card, etc. According to some example embodiments, software components may be loaded to the memory 210 through the communication interface 230, instead of or in addition to the non-transitory computer-readable record medium. For example, the software components may be loaded to the memory 210 of the computer device 200 based on a computer program installed by files received over the network 170.

The processor 220 may be configured to process instructions of a computer program by performing basic arithmetic operations, logic operations, and I/O operations. The computer-readable instructions may be provided by the memory 210 or the communication interface 230 to the processor 220. For example, the processor 220 may be configured to execute received instructions in response to a program code stored in a storage device, such as the memory 210.

The communication interface 230 may provide a function for or associated with communication between the communication apparatus 200 and another apparatus, for example, the aforementioned storage devices, over the network 170. For example, the processor 220 of the computer device 200 may forward a request or an instruction created based on a program code stored in the storage device such as the memory 210, data, and a file, to other apparatuses over the network 170 under control of the communication interface 230. Inversely, one or more of a signal, an instruction, data, a file, etc., from another apparatus may be received at the computer device 200 through the communication interface 230 of the computer device 200. One or more of a signal, an instruction, data, etc., received through the communication interface 230 may be forwarded to the processor 220 or the memory 210, and a file, etc., may be stored in a storage medium, for example, the permanent storage device, further includable in the computer device 200.

The I/O interface 240 may be a device used for interfacing with an I/O device 250. For example, an input device may include a device, such as a microphone, a keyboard, a mouse, etc., and an output device may include a device, such as a display, a speaker, etc. As another example, the I/O interface 240 may be a device for interfacing with an apparatus in which an input function and an output function are integrated into a single function, such as a touchscreen. At least one of the I/O device 250 may be configured as a single apparatus with the computer device 200, for example, may be implemented in a form in which one or more of a touchscreen, a microphone, a speaker, etc., are included in the computer device 200, such as a smartphone.

Alternatively or additionally, according to some example embodiments, the computer device 200 may include a greater or smaller number of components than the number of components of FIG. 2. For example, the computer device 200 may be configured to include at least a portion of the I/O device 250 and/or may further include other components, such as a transceiver and a database.

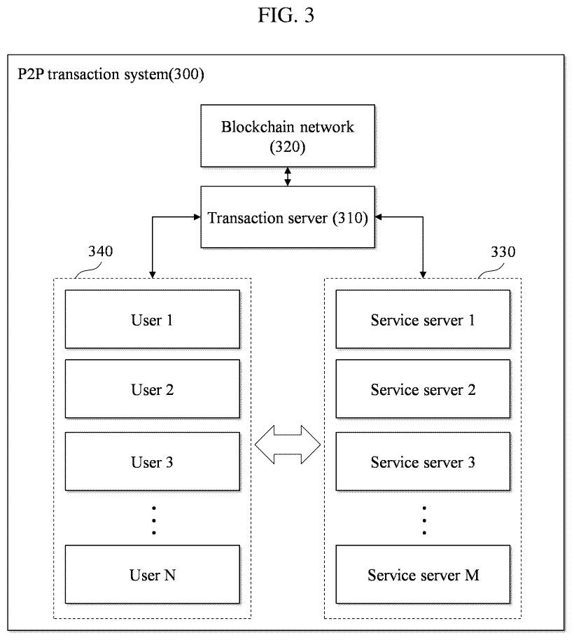

FIG. 3 illustrates an example of a P2P transaction system using a blockchain according to some example embodiments. A P2P transaction system 300 according to the example embodiment may include a transaction server 310, a blockchain network 320, a plurality of service users 330, and a plurality of users 340. Here, each of the plurality of users 340 may be substantially an electronic device (e.g., one or more of the plurality of electronic devices 110, 120, 130, and 140 described with reference to FIG. 1) implemented using the computer device 200 of FIG. 2.

In some example embodiments, the blockchain network 320 may be or may include or be based upon one or more of a Bitcoin network, an Ethereum network, a Litecoin network, a Ripple network, a Dogecoin network, etc.; example embodiments are not limited thereto. In some example embodiments, the blockchain network 320 may be a bespoke network; example embodiments are not limited thereto. In some example embodiments, the blockchain network 320 may operate based on one or more consensus algorithms, such as one or more of a Proof-of-Work consensus algorithm, a Proof-of-Stake consensus algorithm, or a Proof-of-Liquidity consensus algorithm; example embodiments are not limited thereto.

Each of the plurality of service servers 330 may produce a service, such as a service produced and released by a corresponding service producer. Here, each of the plurality of users 340 may access a desired service server through a network (e.g., network 170) using the electronic device and may receive the service. A number of users 340 may be M, and a number of service servers may be N; in some cases M may be greater than, less than, or equal to N and example embodiments are not limited thereto.

Items are present within a service provided from each of the plurality of service servers 330, and a user (e.g., one of the plurality of users 340) may acquire an item defined within a service according to the use of the service provided to the user. Here, each of the plurality of users 340 may be a person; however, example embodiments are not limited thereto, and the plurality of users 340 may represent a person, or an organization, or a group of persons arranged in an organization, etc. In some example embodiments, user 340 may be or may include or correspond to an artificial intelligence; example embodiments are not limited thereto. The item may be provided to the user according to the service use of the user, and may also be provided to the user in such a manner that the user purchases a specific item through an in-service purchase function.

The transaction server 310 may provide a service for item transactions between users, in conjunction with the plurality of service servers 330. For example, the transaction server 310 may provide a function for or associated with tokenization of an item to the plurality of service servers 330. For example, a specific service server may provide an item tokenization function provided from the transaction server 310 to the user through one or more application programming interface (API) calls. Here, the API call for the item tokenization function may be performed through a user interface developed based on software development kit (SDK). In this case, the user may request the transaction server 310 to tokenize a specific item of the user through the item tokenization function. For example, the transaction server 310 may mint an item using the blockchain network 320 and may generate a token (e.g., non-fungible token (NFT)) for or associated with the corresponding item.

In some example embodiments, the transaction server 310 may provide a transaction function for or associated with transactions of the tokenized item between the plurality of users 340. For example, the transaction server 310 may provide a page in which tokenized items are registered to the plurality of users 340 and may provide a function that allows the plurality of users 340 to select and purchase desired tokenized items on the page.

When the user requests tokenization of an item, the transaction server 310 may request a corresponding service server for sealing of the item such that the item is not used or traded in a service. Conversely, when a tokenized item of the user is sold to another user and the other user requests the use of the tokenized item, the transaction server 310 may request the corresponding service server to change ownership of the sealed item and unseal the sealed item. A request from the other user for using the tokenized item may also be performed through API call of the service server for a function that is provided from the transaction server 310.

To provide the function for transactions between users, each of the plurality of service servers 330 needs to be linked and linkage between the plurality of service servers 330 and the transaction server 310 will be further described below.

Also, although FIG. 3 illustrates an example of the centralized transaction server 310, the transaction server 310 may be implemented in a decentralized form through at least some nodes among a plurality of nodes that implements the blockchain network 320.

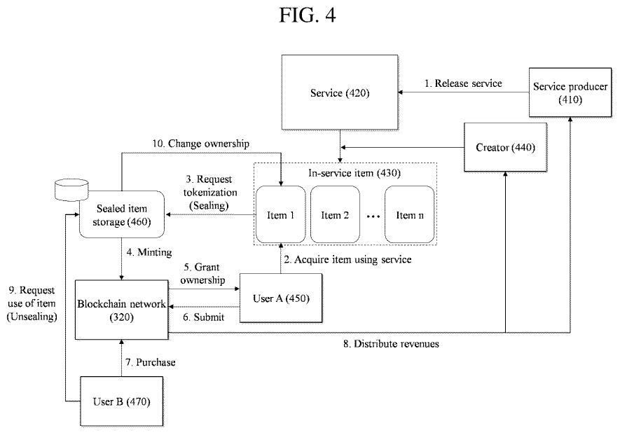

FIG. 4 illustrates an example of a P2P transaction process according to some example embodiments.

In-service items 430 may be defined in a service 420 released by a service producer 410 (operation 1). Here, a creator 440 may be or may include (or correspond to) a third party that is the same as the service producer 410, or that produces an item through an item production interface provided within the service 420. For example, the in-service item 430 may be produced by the service producer 410 or a separate third party (creator 440) and may be defined within the service 420. When defining an item, the sealable property of the item may be added to the item. In some example embodiments, a pre-tokenized item may be supplied through interaction between the service 420 and the blockchain network 320. For example, the item may be provided within the service 420 in a form of a token and, in this case, a process of generating a token corresponding to the item may be omitted.

Here, a user A 450 may acquire an item using the service 420 (operation 2). In some example embodiments illustrated in FIG. 4, it is assumed that the user A 450 acquires item 1 among the in-service items 430 according to the use of the service 420, and/or through purchase in the service 420. Here, a service server (e.g., one of the plurality of service servers 330 shown in FIG. 3) providing the service 420 may provide, to the user A 450, a user interface developed based on SDK that is provided from the linked transaction server 310, and the user A 450 may request tokenization for item 1 through the provided user interface (operation 3). In this case, the corresponding service server may seal item 1 in a sealed item storage 460. Meanwhile, API call that occurs through a tokenization request through the user interface may cause the transaction server 310 to mint item 1 through the blockchain network 320 and to generate a token for item 1 (operation 4). Here, ownership for the token may be granted to the user A 450 (operation 5). For example, the generated token may be moved to an electronic wallet (E-wallet) of the user A 450.

Meanwhile, the user A 450 may submit his or her or their own token by setting transaction conditions (operation 6). When the transaction server 310 is implemented in a centralized form, the transaction server 310 may operate a centralized exchange for the sale of a directly submitted token. In this case, a user B 470 may purchase the token submitted by the user A 450 using an interface of the centralized exchange operated by the transaction server 310 (operation 7). When the transaction server 310 is implemented in a decentralized form, the transaction server 310 may generate a smart contract including transaction conditions and may distribute the same to nodes of the blockchain network 320. In this case, the user B 470 may purchase a token through a process of signing the smart contract (operation 8). The purchased token may be moved to an E-wallet of the user B 470.

The user B 470 that purchases the token may request the use of an item corresponding to the purchased token through the user interface provided from the service server (operation 9). In this case, item 1 sealed in the sealed item storage 460 may be unsealed, and the ownership of item 1 may be changed from the user A 450 to the user B 470 (operation 10). Then, the user B 470 may use his/her own item 1 within the service 420.

An item as a target of transaction between users may include an item in which at least two items are combined or synthesized according to a rule allowed by the service 420 and an item acquired through a process (e.g., item reinforcement in a game service) of adding values within the service 420 due to item property, in addition to a form initially defined within the service 420.

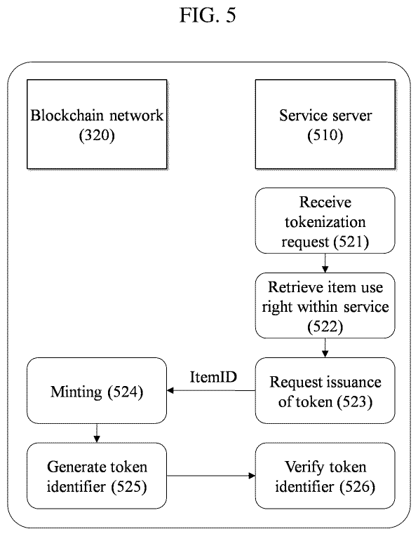

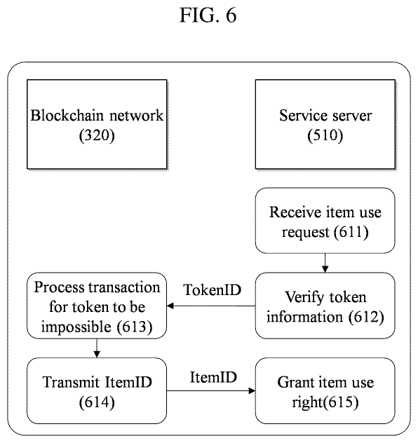

FIG. 5 illustrates an example of a process of sealing an item according to some example embodiments, and FIG. 6 illustrates an example of a process of unsealing an item according to some example embodiments. In some example embodiments illustrated in FIGS. 5 and 6, it is assumed that the transaction server 310 is implemented by at least some of nodes of the blockchain network 320 in a decentralized form.

In some example embodiments illustrated in FIG. 5, a service server 510 may receive a tokenization request for an item of a user from the user using a user interface provided through a service (521). In this case, the service server 510 may retrieve the right to use an in-service item for the item of which tokenization the user requests (522). Then, the service server 510 may request the blockchain network 320 to issue a token for the corresponding item (523). Here, the service server 510 may transmit an item identifier (ItemID) of the corresponding item to the blockchain network 320. The blockchain network 320 may generate the token through minting (524) for the item corresponding to the item identifier in response to the request and may generate a token identifier (TokenID) of the token (525). Here, the blockchain network 320 may record the item identifier in metadata of the token such that an owner of the item identified by the item identifier may be identified through the corresponding token. Since a plurality of services are present, the token may be generated to further include the service identifier (ServiceID).

In some example embodiments illustrated in FIG. 6, the service server 510 may receive a request for using an item corresponding to a token owned by the user from the user using a user interface provided through a service (611). In this case, the service server 510 may verify information of the token of the user (612) and may verify an owner of the corresponding token. When the service server 510 verifies that the corresponding token is owned by the user, the service server 510 may transmit a request for preventing or reducing the likelihood of and/or impact from the corresponding token from being traded to the blockchain network 320 with a token identifier. The blockchain network 320 may process a transaction for the corresponding token to be impossible upon request (613) and then, may extract an item identifier included in metadata of the token and transmit the same to the service server 510 (614). In this case, the service server 510 may unseal the item corresponding to the transmitted item identifier and may grant the item use right for the item to the user (615).

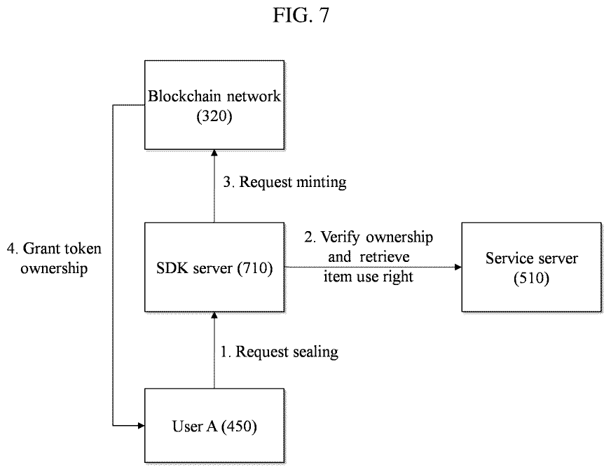

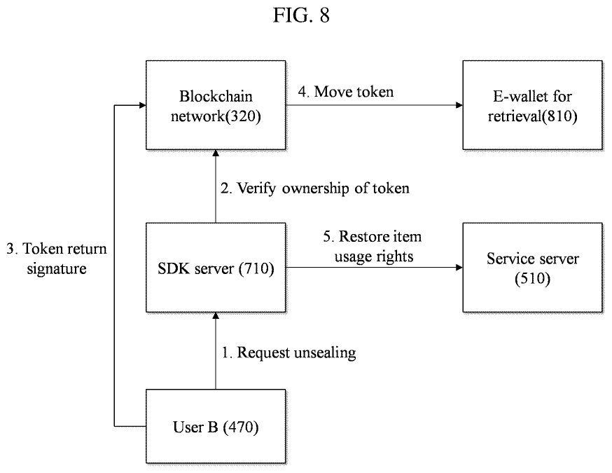

FIG. 7 illustrates an example of a sealing process according to some example embodiments, and FIG. 8 illustrates an example of an unsealing process according to some example embodiments. In some example embodiments illustrated in FIGS. 7 and 8, an SDK server 710 may correspond to the transaction server 310, or may correspond to a portion of the transaction server 310. For example, in the case of providing a centralized exchange, the SDK server 710 may correspond to the transaction server 310. On the other hand, in the providing a decentralized exchange, the transaction server 310 may be implemented in the form that includes at least some nodes among the nodes constituting the blockchain network 320 and the SDK server 710. Here, the decentralized exchange may be implemented by at least some nodes.

In some example embodiments illustrated in FIG. 7, the user A 450 may request the SDK server 710 for sealing. Here, the sealing request may correspond to a tokenization request. As described above, the user A 450 may request the SDK server 710 for sealing through API call using a user interface provided from the service server 510. In this case, the SDK server 710 may verify the ownership of an item through the service server 510 according to the request and may retrieve the item use right. Once the item use right is retrieved, the SDK server 710 may request the blockchain network 320 to mint for the corresponding item. In this case, the blockchain network 320 may generate a token corresponding to the item and may grant the ownership for the token to the user A 450.

In some example embodiments illustrated in FIG. 8, the user B 470 may request the SDK server 710 for unsealing. Here, the unsealing request may correspond to an item use request. Even in this case, the user B 470 may request the SDK server 710 for unsealing through API call using a user interface provided from the service server 510. In this case, the SDK server 710 may verify the ownership of the token through the blockchain network 320 in response to the request. If the token is owned by the user B 470, the blockchain network 320 may move the corresponding token to an E-wallet 810 for retrieval to prevent or reduce the likelihood of and/or impact from the token from being traded through a token return signature of the user B 470. Then, the SDK server 710 may request the service server 510 for restoring the item use right. The service server 510 may restore the item use right (set or change the ownership of the corresponding item to the user B 470), and accordingly, the user B 470 may use the corresponding item within the service provided from the service server 510.

Depending on example embodiments, the token moved to the E-wallet 810 for retrieval may be reused when sealing the same item later.

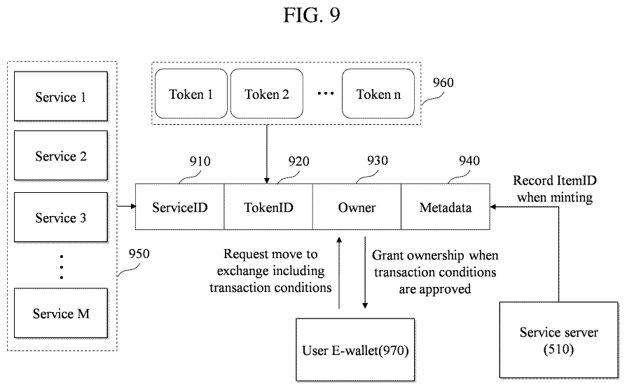

FIG. 9 illustrates an example of token information for trading items of a plurality of services according to some example embodiments. A token according to some example embodiments may include a service identifier (ServiceID) 910, a token identifier (TokenID) 920, ownership information (Owner) 930, and metadata 940.

The service identifier 910 may be used to identify with which service item a corresponding token is associated among a plurality of services 950 provided from the plurality of service servers 330.

The token identifier 920 may be used to identify which token the corresponding token is among a plurality of tokens 960.

The ownership information 930 may be used to identify who owns the corresponding token. The corresponding token may be moved to an E-wallet 970 of a user having the ownership, or may be moved to an exchange for the sale of the token.

As described above, when minting an item, an item identifier transmitted from the service server 510 may be recorded in the metadata 940 of the token.

As described above, the token may include information on to which item of which service the corresponding token corresponds and information on an owner of the token.

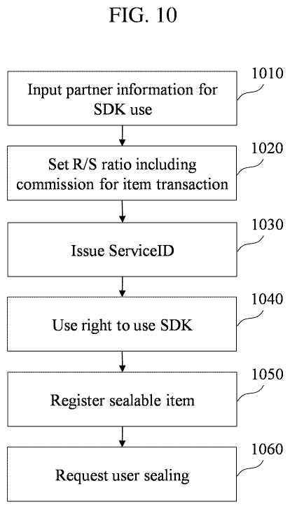

FIG. 10 illustrates an example of a process of receiving a service identifier issued from each service and using SDK for sealing and/or unsealing according to some example embodiments.

In a first process 1010, the SDK server 710 may receive partner information for SDK use from an administrator of the service server 510. For example, the SDK server 710 may provide a user interface to the administrator of the service server 510, and the administrator may enter the partner information for the SDK use through the user interface.

In a second process 1020, the SDK server 720 may set a revenue share (R/S) ratio including commission for item transaction. For example, the SDK server 710 may receive information on the R/S ratio including commission for item transaction through the user interface provided to the administrator of the service server 510, and may set the R/S ratio.

In a third process 1030, the SDK server 720 may issue a service identifier (ServiceID) for the service server 510.

In a fourth process 1040, the SDK server 720 may issue an SDK use right for the service server 510. In this case, the service server 510 may implement a user interface that allows users to request sealing of an item, unsealing of a tokenized item, and submission of the tokenized item through the SDK.

In a fifth process 1050, the SDK server 720 may receive registration of an item that may be sealed from the administrator of the service server 510.

In a sixth process 1060, the SDK server 720 may receive a sealing request from the user. The sealing request may be generated through the user interface implemented by the service server 510 using the SDK, and transmitted to the SDK server 720.

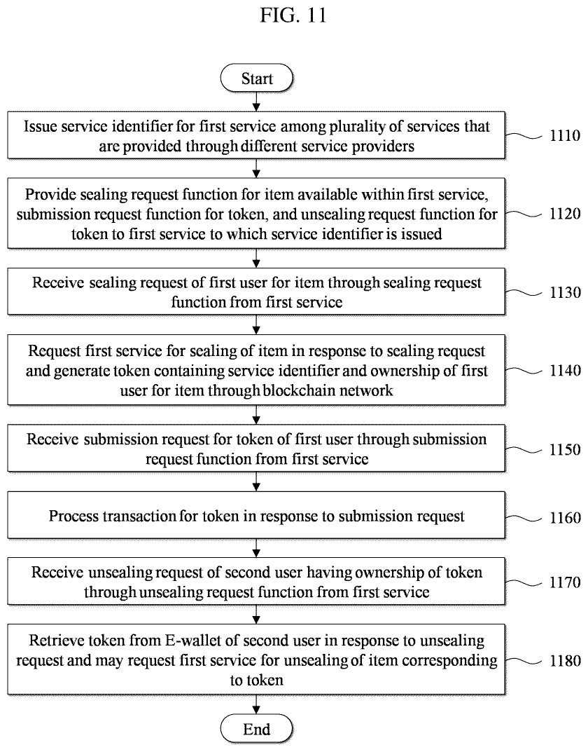

FIG. 11 is a flowchart illustrating an example of a P2P transaction method according to some example embodiments. The P2P transaction method according to the example embodiment may be performed by the computer device 200 that implements the aforementioned transaction server 310. Here, the processor 220 of the computer device 200 may be implemented to execute a control instruction according to a code of at least one computer program or a code of an OS included in the memory 210. Here, the processor 220 may control the computer device 200 to perform operations 1110 to 1180 included in the method of FIG. 11 in response to a control instruction provided from a code stored in the computer device 200.

In operation 1110, the computer device 200 may issue a service identifier for a first service among a plurality of services that are provided through different service providers. Depending on example embodiments, the computer device 200 may receive partner information and information on an R/S ratio including commission for item transaction from an administrator of the first service. Then, the computer device 200 may register the first service based on the received partner information and information on the R/S ratio, and may generate a service identifier for the registered first service. This service identifier may be used to identify in which service each item and token is used in a situation in which a plurality of services are present. In some example embodiments, the computer device 200 may further issue the right to use SDK for implementation of a sealing request function, a submission request function, and/or an unsealing request function to the first service.

In operation 1120, the computer device 200 may provide a sealing request function for an item available within the first service, a submission request function for a token, and an unsealing request function for the token to the first service to which the service identifier is issued. The sealing request function may include a function for transmitting a request for sealing the item available within the first service to the computer device 200, and the submission request function may include a function for transmitting a request for registering the token to an exchange to the computer device 200 for transaction of the generated token. Also, the unsealing request function may include a function for transmitting a request for unsealing the sealed item to the computer device 200.

In operation 1130, the computer device 200 may receive a sealing request of a first user for the item through the sealing request function from the first service. Here, the computer device 200 may further receive the item identifier of the item with the sealing request. The sealing request function may include a function for transmitting a request for sealing the item available within the first service to the computer device 200. Through this, the first user may transmit the sealing request to the computer device 200 within the first service.

In operation 1140, the computer device 200 may request the first service for sealing of the item in response to the sealing request and may generate a token containing the service identifier and ownership of the first user for the item through a blockchain network. Here, the computer device 200 may generate a token that further includes the item identifier further received in operation 1130.

In operation 1150, the computer device 200 may receive a submission request for the token of the first user through the submission request function from the first service. As described above, the submission request function may include a function for transmitting a request for registering the token to the exchange to the computer device 200 for transaction of the generated token. Through this, the first user may transmit the submission request to the computer device 200 within the first service.

In operation 1160, the computer device 200 may process a transaction for the token in response to the submission request. As described above, the computer device 200 may register the token through a centralized exchange and process the transaction of the token, or may register the token through a decentralized exchange that is implemented through at least some nodes among nodes constituting the blockchain network and process the transaction of the token. Here, the decentralized exchange may process the transaction of the token based on a signature on smart contract deployed to the at least some nodes.

In operation 1170, the computer device 200 may receive an unsealing request of a second user having ownership of the token through the unsealing request function from the first service. Here, the second user may be the same user as the first user or may be another user that purchases the token from the first user. For example, if the transaction for the token is completed in operation 1160 and the other user purchases the token of the first user, the second user may be the other user that purchases the token. On the contrary, if the transaction for the token is not completed in operation 1160 and the ownership of the token belongs to the first user, the second user may be the same user as the first user. The unsealing request function may include the function for transmitting the request for unsealing the sealed item to the computer device 200, and through this, the second user may transmit the unsealing request to the computer device 200 within the first service.

In operation 1180, the computer device 200 may retrieve the token from an E-wallet of the second user in response to the unsealing request and may request the first service for unsealing of an item corresponding to the token. For example, the computer device 200 may move the token from the E-wallet of the second user to an E-wallet for retrieval and may change the token to an unusable state. In some example embodiments, the first service may unseal the item corresponding to the token upon request, such that the second user may use the corresponding item within the first service.

As described above, according to example embodiments, it may be possible to provide a method and system for a P2P transaction using blockchain.

In some example embodiments, the method and/or the system for P2P transactions implemented on a blockchain may provide more or improved security and/or more or an improved proof-of-ownership record of various transactions. In some example embodiments, the use of a blockchain for P2P transactions may enable, for example, smart contracts, or self-executing contracts that automatically or at least partially automatically help distribute profit sharing. Alternatively or additionally in some example embodiments, the P2P transactions using blockchain may improve upon transactions by creating an immutable chain of ownership associated with the E-wallets, recording the transaction. In addition, in order to tokenize items on the blockchain and provide peer-to-peer trading services for tokenized items, each of the various services can mint items through a blockchain network-based trading server according to example embodiments. This may allow each of the services to enable peer-to-peer trading without having to spend significant time, physical, and resource costs to convert the services to a blockchain-based system.

The systems or the apparatuses described above may be implemented using hardware components, software components, and/or combination thereof. For example, the apparatuses and components described herein may be implemented using one or more general-purpose or special purpose computers, for example, one or more of a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For simplicity, the description of the processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, virtual equipment, a computer storage medium or device, or in a propagated signal wave capable of providing instructions or data to or being interpreted by the processing device. The software also may be distributed over network coupled computer devices so that the software is stored and executed in a distributed fashion. The software and data may be stored by one or more computer readable storage mediums.

The methods according to some example embodiments may be configured in a form of program instructions performed through various computer methods and recorded in non-transitory computer-readable media. The media may include, alone or in combination with program instructions, a data file, a data structure, and the like. The media may continuously store computer-executable programs or may temporarily store the same for execution or download. Also, the media may be various types of recording devices or storage devices in a form in which one or a plurality of hardware components are combined. Without being limited to media directly connected to a computer device, the media may be distributed over the network. Non-limiting examples of the media include magnetic media such as one or more of hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Non-limiting examples of other media may include recording media and storage media managed by an app store that distributes applications or a site, a server, and the like that supplies and distributes other various types of software. Non-limiting examples of program instructions include machine code as produced by a compiler and an advanced language code executable by a computer using an interpreter.

While the descriptions includes specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, other implementations, other example embodiments, and equivalents are within the scope of the following claims. Additionally, example embodiments are not necessarily mutually exclusive with one another. For example, some example embodiments may include one or more features described with reference to one or more figures, and may also include one or more other features described with reference to one or more other figures.

What is claimed is:

1. A peer-to-peer (P2P) transaction method of a computer device comprising at least one processor, the P2P transaction method comprising:
issuing, by the at least one processor, a service identifier associated with a first service among a plurality of services, the plurality of services being provided through different service providers;
providing, by the at least one processor, a sealing request function associated with an item available within the first service and a submission request function associated with a token to the first service to which the service identifier is issued;
receiving, by the at least one processor, a sealing request of a first user associated with the item through the sealing request function from the first service;
requesting, by the at least one processor, the first service associated with sealing of the item in response to the sealing request;
generating a token containing the service identifier and ownership of the first user associated with the item through a blockchain network;
receiving, by the at least one processor, a submission request for the token of the first user through the submission request function from the first service; and
processing, by the at least one processor, a transaction associated with the token in response to the submission request.

2. The P2P transaction method of claim 1, wherein the receiving of the sealing request comprises further receiving an item identifier of the item, and
the generating of the token comprises generating the token further containing the item identifier of the item received with the sealing request.

3. The P2P transaction method of claim 1, wherein the providing comprises further providing an unsealing request function associated with the token to the first service, and
the P2P transaction method further comprises:
receiving, by the at least one processor, an unsealing request of a second user having ownership of the token through the unsealing request function from the first service;
retrieving, by the at least one processor, the token from an electronic wallet (E-wallet) of the second user in response to the unsealing request; and
requesting the first service associated with unsealing of the item corresponding to the token.

4. The P2P transaction method of claim 3, wherein the requesting comprises:
moving the token from the E-wallet of the second user to another E-wallet, the moving the token associated with retrieval; and
changing the token to be in an unusable state.

5. The P2P transaction method of claim 3, wherein the second user is same user as the first user or is another user having purchased the token from the first user.

6. The P2P transaction method of claim 1, wherein the issuing of the service identifier comprises:
receiving partner information and information on a revenue share (R/S) ratio including commission for item transaction, the receiving partner information and information on an R/S ratio from an administrator of the first service;
registering the first service based on the received partner information and information on the R/S ratio; and
generating and providing a service identifier for the registered first service.

7. The P2P transaction method of claim 1, wherein the issuing of the service identifier comprises further issuing a right to use software development kit (SDK) associated with implementation of the sealing request function and the submission request function to the first service.

8. The P2P transaction method of claim 1, wherein the processing of the transaction comprises registering the token through a centralized exchange and processing the transaction of the token.

9. The P2P transaction method of claim 1, wherein the processing of the transaction comprises registering the token through a decentralized exchange implemented through at least some nodes among nodes included in the blockchain network, and processing the transaction of the token.

10. The P2P transaction method of claim 9, wherein the decentralized exchange processes the transaction of the token based on a signature on smart contract deployed to the at least some nodes.

11. A non-transitory computer-readable recording medium storing instructions that, when executed by a processor, cause the processor to implement the method of claim 1 on the computer device.

12. A computer device comprising:
at least one processor configured to execute computer-readable instructions,
wherein the at least one processor causes the computer device to,
issue a service identifier associated with a first service among a plurality of services provided through different service providers,
provide a sealing request function associated with an item available within the first service and a submission request function for a token to the first service to which the service identifier is issued,
receive a sealing request of a first user associated with the item through the sealing request function from the first service,
request the first service associated with sealing of the item in response to the sealing request;
generating a token containing the service identifier and ownership of the first user associated with the item through a blockchain network,
receive a submission request associated with the token of the first user through the submission request function from the first service, and
process a transaction for the token in response to the submission request.

13. The computer device of claim 12, wherein the at least one processor causes the computer device to,
further provide an unsealing request function associated with the token to the first service,
receive an unsealing request of a second user having ownership of the token through the unsealing request function, the receiving the unsealing request from the first service, and
retrieve the token from an electronic wallet (E-wallet) of the second user in response to the unsealing request and request the first service for unsealing of an item corresponding to the token.

14. The computer device of claim 12, wherein, in issuing the service identifier, the at least one processor causes the computer device to,
receive partner information and information on a revenue share (R/S) ratio including commission for item transaction, the receiving partner information and information on the R/S ratio from an administrator of the first service,
register the first service based on the received partner information and on information on the R/S ratio, and
generate and provide a service identifier for the registered first service.

15. The computer device of claim 12, wherein the at least one processor causes the computer device to further issue a right to use software development kit (SDK) associated with implementation of the sealing request function and the submission request function to the first service.

16. The computer device of claim 12, wherein, in processing the transaction, the at least one processor causes the computer device to register the token through a centralized exchange and process the transaction of the token, or to register the token through a decentralized exchange implemented through at least some nodes among nodes included in the blockchain network and process the transaction of the token.
